(19) United States
(12) Patent Application Publication
(10) Pub. No.: US 2007/0272846 A1
(43) Pub. Date: Nov. 29, 2007

(54) IMAGE CHIP PACKAGE STRUCTURE AND THE METHOD OF MAKING THE SAME

(75) Inventor: Cheng-Chiao WU, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Taiwan Electronic Packaging Co., Ltd., Chu-Pei (TW)

(21) Appl. No.: 11/836,020

(22) Filed: Aug. 8, 2007

(30) Foreign Application Priority Data
Oct. 17, 2005 (TW) 94136242

(51) Int. Cl. H01J 5/02; H01J 40/14

(52) U.S. Cl. 250/239

(57) ABSTRACT

An image chip package structure includes a carrier member, an image sensing die, a protective shield and a plurality of wires. The image sensing die has a side connected to the carrier and an opposite side with an image sensing region and a plurality of die bonding pads around the image sensing region. The protective shield has a connecting portion and a top shield portion. The connecting portion is connected to the image sensing die between the image sensing region and the die bonding pads to isolate the image sensing region and the die bonding pads and to surround the image sensing region. The top shield portion is connected to the connecting portion and above the image sensing region. The wires electrically connect the die bonding pads of the image sensing die and the carrier member.

### BACKGROUND OF THE INVENTION

1. Field of the Invention

The present invention relates to an image chip package, and more particularly to an image chip package structure and the method of making the same.

2. Description of the Related Art

As the improvement of computer technology, the integrated circuits are made as smaller as possible. The integrated circuit has to be packaged prior to being mounted in the electronic device. The package technique has to go with the integrated circuits to reduce the size thereof.

The conventional package technique provides a die attached on a circuit board directly, so called direct chip attach (DCA), and wire bonding to connect bonding pads of the die to the circuit board. While the die is an image sensing die, it has an image sensing region on a top of the die to sense image. In the process of package of such image sensing dies, it will leave dirt on the image sensing region occasionally that affects image sensing. In the connection of the wires, it has a high risk to damage the chip because the chip is very small.

### SUMMARY OF THE INVENTION

The present invention has been accomplished under the circumstances in view. It is therefore one object of the present invention to provide an image chip package structure and the method of making the same, which provides a less chance to damage or pollute the image sensing region of the die in wire bonding procedure.

According to the objective of the present invention, an image chip package structure includes a carrier member, an image sensing die, a protective shield and a plurality of wires. The image sensing die has a bottom side connected to the carrier and a top side with an image sensing region and a plurality of die bonding pads around the image sensing region. The protective shield has a connecting portion and a top shield portion. The connecting portion is connected to the image sensing die between the image sensing region and the die bonding pads to isolate the image sensing region and the die bonding pads and to surround the image sensing region. The top shield portion is connected to the connecting portion and above the image sensing region. The wires electrically connect die bonding pads of the image sensing die and the carrier member.

### BRIEF DESCRIPTION OF THE DRAWINGS

FIG. 1 is a sectional view of a first preferred embodiment of the present invention;

FIG. 2 is a top view of the first preferred embodiment of the present invention;

FIG. 3 is a sectional view of the first preferred embodiment of the present invention, showing the die being packaged;

FIG. 4 is a sectional view of a second preferred embodiment of the present invention;

FIG. 5 is a sectional view of a third preferred embodiment of the present invention;

FIG. 6 is a top view of the third preferred embodiment of the present invention;

FIG. 7 is a sectional view of a fourth preferred embodiment of the present invention;

FIG. 8 is a top view of the fourth preferred embodiment of the present invention;

FIG. 9 is a sectional view of a fifth preferred embodiment of the present invention;

FIG. 10 is a top view of the fifth preferred embodiment of the present invention;

FIG. 11 is a sectional view of a sixth preferred embodiment of the present invention;

FIG. 12 is a sectional view of a seventh preferred embodiment of the present invention;

FIG. 13 is a sectional view of an eighth preferred embodiment of the present invention; and

FIG. 14 is a sectional view of a ninth preferred embodiment of the present invention.

### DETAILED DESCRIPTION OF THE INVENTION

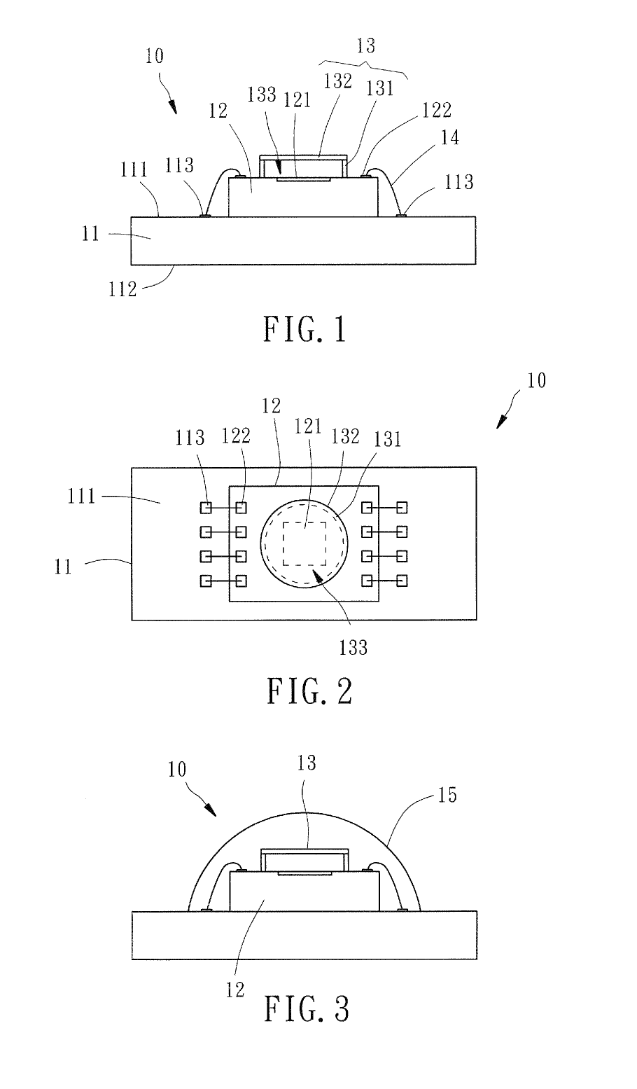

As shown in FIG. 1 and FIG. 2, an image chip package structure 10 of the first preferred embodiment of the present invention includes a carrier member 11, an image sensing die 12, a protective shield 13 and a plurality of wires 14.

The carrier member 11, which is a circuit board or lead frame pre-mold made of plastic, reinforced plastic, glass fiber, ceramics, or other relative materials, has a top side 111 and a bottom side 112 opposite to the top side 111. The carrier member 11 has a conductor pattern (not shown) and bonding pads 113 electrically connected to the conductor pattern on the top side 111.

The image sensing die 12 has a top side and a bottom side. The image sensing die 12 has the bottom side attached on the top side 111 of the carrier member 11 by epoxy resin, silicon resin, low melting temperature glass, adhesive or other relative materials. The image sensing die 12 has an image sensing region 121 at a center of the top side thereof for image sensing and die bonding pads 122 electrically connected to the image sensing die 12 around the image sensing region 121.

The protective shield 13 has a connecting portion 131 and a top shield portion 132. The connecting portion 131, which is an annular member in the present invention made of plastic, glass, glass fiber, metal, ceramics, or other relative materials, has a space 133 therein. The connecting portion 131 is attached on the top side of the image sensing die 12 between the image sensing region 121 and the die bonding pads 122, which means the image sensing region 121 is in the space 133 of the connecting portion 131, and the die bonding pads 122 are outside of the connecting portion 131. The top shield portion 132, which is a disk in the present invention made of plastic, glass, glass fiber, or other relative materials, is connected to a top edge of the connecting portion 131 to seal the image sensing region 121 in the space 133. The top shield portion 132 is above the image sensing region 121 and keeps a distance from the image sensing region 121. In the present invention, the top shield portion 132 has the same size as the connecting portion 131. In practice, the top shield portion 132 may be bigger or smaller than the connecting portion 131.

The wires 14, which are made of gold, aluminum, or other relative materials, are connected to the die bonding pads 122 of the image sensing die 12 and the bonding pads 113 of the carrier member 11 by conventional wire bonding technique for electrical connection between the image sensing die 12 and the carrier member 11.

The elements and construction of the image chip package structure 10 are described above, and the characters of the present are described hereunder:

The main steps of making the image chip package structure 10 include attaching the image sensing die 12 on the top side 111 of the carrier member 11, and then adhesively connecting the protective shield 13 on the top side 111 of the carrier member 11 to cover the image sensing region 121 and leave the die bonding pads 122 outside, and then proceeding wire bonding procedure to electrically connect the image sensing die 12 and the carrier member 11 by the wires 13. The image sensing region 121 of the image sensing die 12 is hidden in the protective shield 13 prior to wire bonding procedure that the protective shield 13 may protect the image sensing die 12 from being damaged and being polluted by the solder in the following wire bonding procedure, and the die bonding pads 122 are left out of the protective shield 13 that the wire bonding procedure will not be affected by the protective shield 13. The present invention may increase speed of making the image chips and reduce the ratio of defective thereof. An alternated process of making the image chip package structure 10 is mounting the protective shield 13 on the image sensing die 12, and then attaching the image sensing die 12 on the top side 111 of the carrier member 11, and then proceeding the wire bonding procedure. It has the same function and result.

While the top shield portion of the protective shield is made of transparent glass or plastic, it may provides a filter layer, which may an IR-coated layer or anti-reflection layer to filter infrared rays or eliminate reflection, on the top shield portion to keep a well optical property.

As shown in FIG. 3, an encapsulant 15, which may be epoxy or other insulating materials, is formed over the image sensing die 12 and the protective shield 13 to prevent the image sensing die 12 form pollution and damage.

As shown in FIG. 4, an image chip package structure 20 of the second preferred embodiment of the present invention, which is similar to the first preferred embodiment, includes a carrier member 21, an image sensing die 22, a protective shield 23 and a plurality of wires 24. The different parts of the second preferred embodiment are:

The protective shield 23 is a single unit including an integrated connecting portion 231 and top shield portion 232. The connecting portion 231 is adhesively connected to a top of the image sensing die 22 between an image sensing region 221 and die bonding pads 222 of the image sensing die 22. The top shield portion 232 is above the image sensing region 221.

The second preferred embodiment has the same function as the first preferred embodiment, furthermore, the second preferred embodiment has no step of connecting the integrated connecting portion 231 and that top shield portion 232 that will simplify the process.

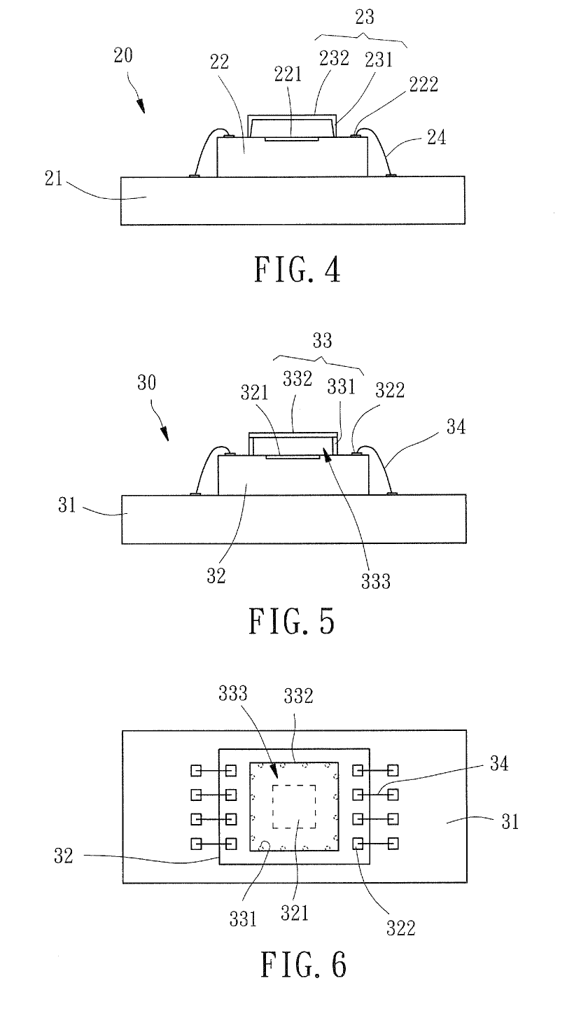

As shown in FIG. 5 and FIG. 6, an image chip package structure 30 of the third preferred embodiment of the present invention, which is similar to the first and second preferred embodiments, includes a carrier member 31, an image sensing die 32, a protective shield 33 and a plurality of wires 34. The different parts of the third preferred embodiment are:

The protective shield 33 has a connecting portion 331, which includes a plurality of posts standing side by side on a top side of the image sensing die 32 between an image sensing region 321 and die bonding pads 322. These posts surround a rectangular space 333 to receive the image sensing region 321 therein. The top shield portion 332 is a rectangular plate adhesively connected to distal ends of the posts (the connecting portion 331). The top shield portion 332 is above the image sensing region 321 and keeps a distance from the image sensing region 321 to close the image sensing region 321 in the space 332.

Although there are gaps between the posts, they still may protect the image sensing region from damage and pollution that achieve the objective of the present invention.

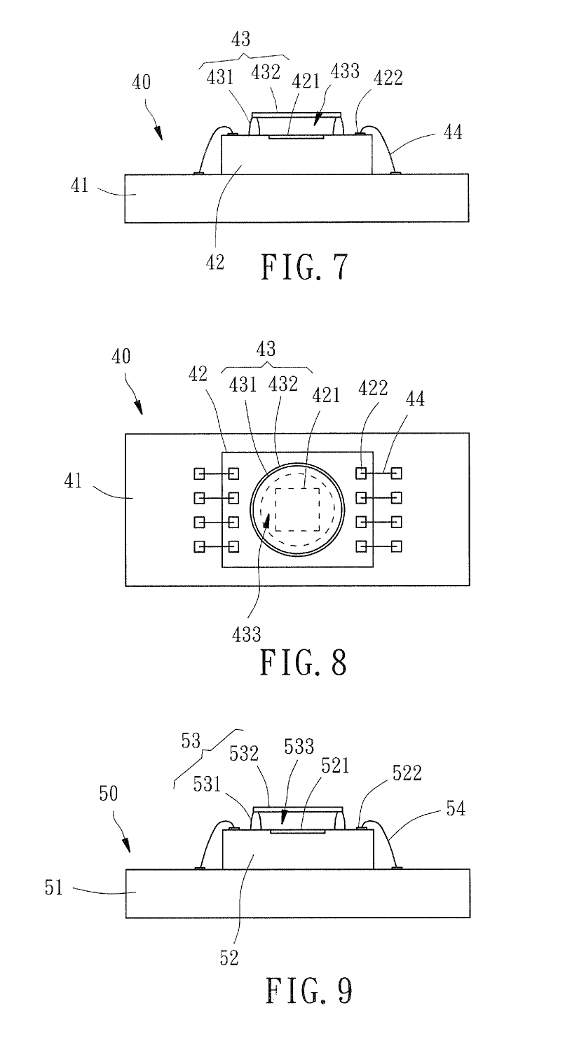

As shown in FIG. 7 and FIG. 8, an image chip package structure 40 of the fourth preferred embodiment of the present invention, which is similar to above preferred embodiments, includes a carrier member 41, an image sensing die 42, a protective shield 43 and a plurality of wires 44. The different parts of the fourth preferred embodiment are:

The protective shield 43 has a connecting portion 431, which is an adhesive member made of silicon, epoxy, acrylic, polyamide or other relative materials. The adhesive member is coated on the top side of the image sensing die 42, like an annular wall, between an image sensing region 321 and die bonding pads 322. The annular wall is higher than the image sensing region 321. A top shield portion 432 is connected to a top of the connecting portion 431 to seal the image sensing region 321 in a space 433 of the connecting portion 431. It achieves the objective of the present invention also.

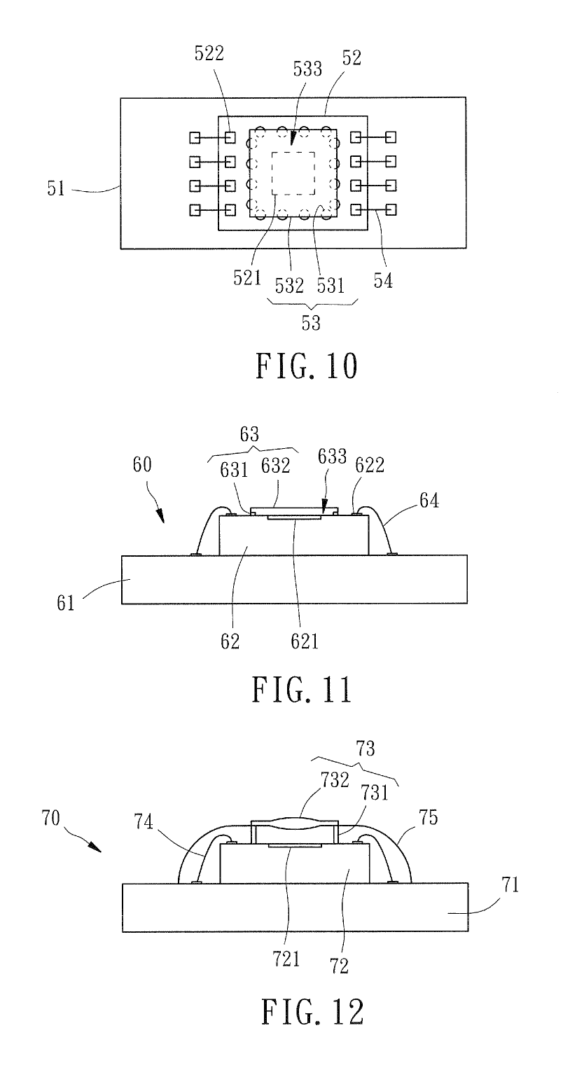

As shown in FIG. 9 and FIG. 10, an image chip package structure 50 of the fifth preferred embodiment of the present invention, which is similar to above preferred embodiments, includes a carrier member 51, an image sensing die 52, a protective shield 53 and a plurality of wires 54. The different parts of the fifth preferred embodiment are:

A connecting portion 531 of the protective shield 53 has a plurality of posts, which are adhesive members made of silicon, epoxy, acrylic, polyamide or other relative materials. The posts stand side by side on a top side of the image sensing die 52 between an image sensing region 521 and die bonding pads 522. These posts surround a rectangular space 533 to receive the image sensing region 521 therein. The top shield portion 532 is a rectangular plate adhesively connected to distal ends of the posts (the connecting portion 531). The top shield portion 532 is above the image sensing region 521 and keeps a distance from the image sensing region 321 to close the image sensing region 321 in the space 532.

As shown in FIG. 11, an image chip package structure 60 of the sixth preferred embodiment of the present invention, which is similar to above preferred embodiments, includes a carrier member 61, an image sensing die 62, a protective shield 63 and a plurality of wires 64. The different parts of the sixth preferred embodiment are:

A connecting portion 631 of the protective shield 63 is an annular wall like adhesive member on a top side of the image sensing die 62 between an image sensing region 621 and die bonding pads 622 to receive the image sensing region 621 in a space 533 within the connecting portion 631. The connecting portion 631 is higher than the image sensing region 621. The protective shield portion 63 has a top shield portion 632 adhesively connected to a distal end of the connecting portion 631. The top shield portion 632 has a top side and a bottom side, wherein the top side is higher than the image sensing region 621 and the bottom side is adhesively attached on the image sensing region 621 directly to seal the image sensing region 621 in the space 533 of the connecting portion 631. It achieves the objective of the present invention also.

An alternated embodiment of the sixth preferred embodiment is that the connecting portion has a plurality adhesive posts standing side by side on the image sensing die between the image sensing region and the die bonding pads. It achieves the objective of the present invention, except that the adhesive members may be replaced easily that is good for repeated use and repair.

As shown in FIG. 12, an image chip package structure 70 of the seventh preferred embodiment of the present invention, which is similar to above preferred embodiments, includes a carrier member 71, an image sensing die 72, a protective shield 73 and a plurality of wires 74. The different parts of the seventh preferred embodiment are:

The protective shield 73 has a top shield portion 732, which is a lens, attached on a connecting portion 731 that the top shield portion 732 is above an image sensing region 721 of the image sensing die 72 and keeps a distance from the image sensing region 721. The top shield portion 732 may help focus function to overcome the focusing problem of the conventional device. An encapsulant 75 is formed over the connecting portion 731 of the protective shield 73 and the image sensing die 72 but the top shield portion 732. That is, a high of the encapsulant 75 is lower than the top shield portion 732 that the image sensing die 72 may sense a better image via the top shield portion 732.

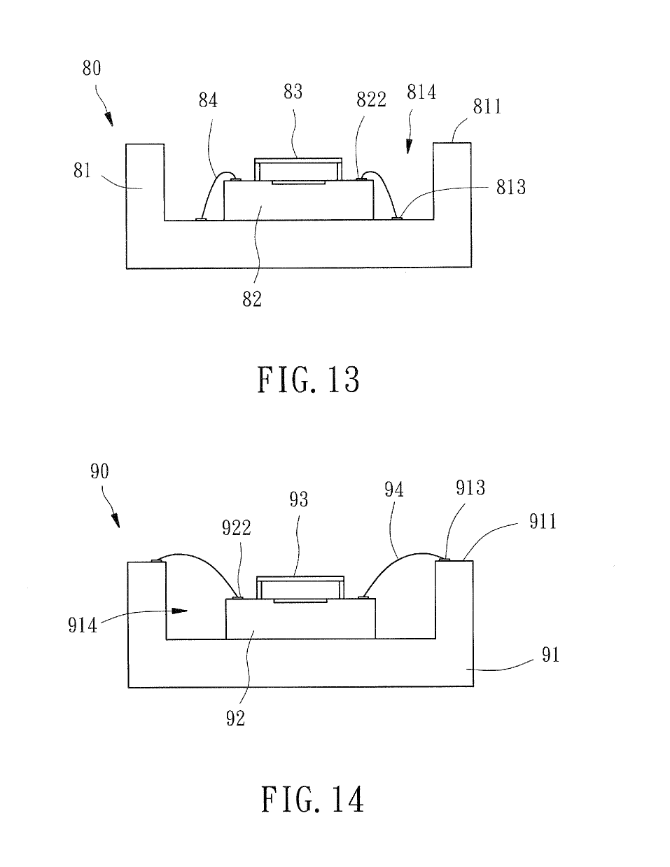

As shown in FIG. 13, an image chip package structure 80 of the eighth preferred embodiment of the present invention, which is similar to above preferred embodiments, includes a carrier member 81, an image sensing die 82, a protective shield 83 and a plurality of wires 84. The different parts of the eighth preferred embodiment are:

The carrier member 81 has a receiving portion 814, which is a recess on a top side 811 thereof, and the image sensing die 82 is received in the receiving portion 814. Wire bonding process is performed to electrically connect die bonding pads 822 of the image sensing die 82 and bonding pads 814 of the carrier member 81 on a bottom side of the receiving portion 814 by wires 84 for electrical connection between the image sensing die 82 and the carrier member 81.

As shown in FIG. 14, an image chip package structure 90 of the ninth preferred embodiment of the present invention, which is similar to the eighth preferred embodiments, includes a carrier member 91, an image sensing die 92, a protective shield 93 and a plurality of wires 94. The different parts of the ninth preferred embodiment are:

The carrier member 91 has a receiving portion 914, which is a recess on a top side 911 thereof, and the image sensing die 92 is received in the receiving portion 914. Wire bonding process is performed to electrically connect die bonding pads 922 of the image sensing die 92 and bonding pads 914 of the carrier member 81 on the top side 911 beyond the receiving portion 914 by wires 84 for electrical connection between the image sensing die 92 and the carrier member 91. The ends of the wires 94 connected to the bonding pads 914 of the carrier member 91 are almost horizontal that the image chip package structure 90 is shorter and narrower.

Although a particular embodiment of the invention has been described in detail for purposes of illustration, various modifications and enhancements may be made without departing from the spirit and scope of the invention.

What is claimed is:

1. An image chip package structure, comprising:
a carrier member;
an image sensing die having a side connected to the carrier and an opposite side with an image sensing region and a plurality of die bonding pads around the image sensing region;
a protective shield having a connecting portion, which is connected to the image sensing die between the image sensing region and the die bonding pads to isolate the image sensing region and the die bonding pads and to surround the image sensing region, and a top shield portion, which is connected to the connecting portion and above the image sensing region; and
a plurality of wires electrically connecting the die bonding pads of the image sensing die and the carrier member.

2. The image chip package structure as defined in claim 1, wherein the carrier member is a circuit board or a lead frame pre-mold made of plastic, reinforced plastic, glass fiber, or ceramics.

3. The image chip package structure as defined in claim 1, wherein the carrier member has a top side, on which a conductor pattern and a plurality of bonding pads electrically connected to the conductor pattern are provided, and a bottom side opposite to the top side, and the wires have opposite ends connected to the die bonding pads of the image sensing die and the bonding pads of the carrier member respectively.

4. The image chip package structure as defined in claim 1, wherein the carrier member has a top side, on which a receiving portion with a predetermined width and a depth to receive the image sensing die therein, a conductor pattern, and a plurality of bonding pads electrically connected to the conductor pattern are provided, and a bottom side opposite to the top side, and the wires have opposite ends connected to the die bonding pads of the image sensing die and the bonding pads of the carrier member respectively.

5. The image chip package structure as defined in claim 3, wherein the carrier member has a top side, on which a receiving portion with a predetermined width and a depth to receive the image sensing die therein is provided, and on a bottom side of the receiving portion, a conductor pattern and a plurality of bonding pads are provided, and the wires have opposite ends connected to the die bonding pads of the image sensing die and the bonding pads of the carrier member respectively.

6. The image chip package structure as defined in claim 3, wherein the image sensing die has a top side and a bottom side, and the image sensing die has the bottom side is attached on the carrier member directly by epoxy resin, silicon resin, low temperature glass or adhesive.

7. The image chip package structure as defined in claim 3, wherein the connecting portion of the protective shield is made of plastic, glass, glass fiber, metal, or ceramics.

8. The image chip package structure as defined in claim 1, wherein the top shield portion of the protective shield is made of plastic, glass, or glass fiber.

9. The image chip package structure as defined in claim 1, wherein the top shield portion of the protective shield is made of glass, on which a filter layer is provided to change an optical character.

10. The image chip package structure as defined in claim 9, wherein the filter layer filters infrared rays.

11. The image chip package structure as defined in claim 9, wherein the filter layer reflects light.

12. The image chip package structure as defined in claim 1, wherein the top shield portion of the protective shield is transparent.

13. The image chip package structure as defined in claim 1, wherein the connecting portion of the protective shield is an annular member with a space therein, an edge of which is connected to the image sensing die between the image sensing region and the die bonding pads, and the image sensing die is received in the space.

14. The image chip package structure as defined in claim 1, wherein the top shield portion of the protective shield is an insulating plate connected to the connecting portion that the top shield portion is above the image sensing region and keeps a distance from the image sensing region.

15. The image chip package structure as defined in claim 1, wherein the connecting portion of the protective shield has a plurality of posts standing side by side on image sensing die between the image sensing region and the die bonding pads to surround a space therewithin for receiving the image sensing region.

16. The image chip package structure as defined in claim 1, wherein the top shield portion of the protective shield is a rectangular insulating plate connected to the connecting portion that the top shield portion keeps a distance from the image sensing region to seal the image sensing region thereunder.

17. The image chip package structure as defined in claim 1, wherein the connecting portion of the protective shield is an adhesive member made of epoxy resin, silicon resin, acrylic, polyamide between the image sensing region and the die bonding pads.

18. The image chip package structure as defined in claim 17, wherein the connecting portion is higher than the image sensing region.

19. The image chip package structure as defined in claim 1, wherein the connecting portion of the protective shield has a plurality of adhesive posts made of epoxy resin, silicon resin, acrylic, polyamide between the image sensing region and the die bonding pads.

20. The image chip package structure as defined in claim 18, wherein the connecting portion is higher than the image sensing region.

21. The image chip package structure as defined in claim 19, wherein the connecting portion is peelable for repeated use.

22. The image chip package structure as defined in claim 1, wherein the connecting portion of the protective shield is an adhesive member between the image sensing region and the die bonding pads with a height higher than the image sensing region.

23. The image chip package structure as defined in claim 1, wherein the connecting portion of the protective shield has a plurality of adhesive members standing side by side on the image sensing die between the image sensing region and the die bonding pads with heights higher than the image sensing region.

24. The image chip package structure as defined in claim 1, wherein the top shield portion of the protective shield has a lens for focusing.

25. The image chip package structure as defined in claim 1, wherein the connecting portion of the protective shield is connected to the image sensing die by an adhesive.

26. The image chip package structure as defined in claim 1, wherein the top shield portion of the protective shield is connected to the connecting portion by an adhesive.

27. The image chip package structure as defined in claim 1, wherein the connecting portion and the top shield portion of the protective shield are formed on an integral.

28. The image chip package structure as defined in claim 1, further comprising an encapsulant covering the image sensing die and the protective shield.

29. The image chip package structure as defined in claim 28, wherein the encapsulant uncovers the top shield portion.

30. A method of packaging an image chip, comprising the steps of:
providing a carrier member;
connecting an image sensing die on the carrier member, wherein the image sensing die has a top side, on which an image sensing region and a plurality of die bonding pads surrounding the image sensing region are provided, and a bottom side opposite to the top side to be connected to the carrier member;
connecting a protective shield on the top side of the image sensing die to cover the image sensing region but the die bonding pads; and
bonding a plurality of wires to the die bonding pads of the image sensing die and the carrier member respectively for electrical connection between the image sensing die and the carrier member.

31. The method as defined in claim 30, further comprising the step of providing an encapsulant covering the image sensing die and the protective shield after the step of bonding the wires.

32. A method of packaging an image chip, comprising the steps of:
providing an image sensing die, on which an image sensing region and a plurality of die bonding pads surrounding the image sensing regions are provided;
connecting a protective shield on the image sensing die to cover the image sensing region but the die bonding pads; and
connecting the image sensing die on a carrier member; and
bonding a plurality of wires to the die bonding pads of the image sensing die and the carrier member respectively for electrical connection between the image sensing die and the carrier member.

33. The method as defined in claim 32, further comprising the step of providing an encapsulant covering the image sensing die and the protective shield after the step of bonding the wires.
